(19) United States
(12) Patent Application Publication
(10) Pub. No.: US 2013/0240567 A1
(43) Pub. Date: Sep. 19, 2013

(54) Fluid Extrusion Bottle

(71) Applicant: Juan Hong CHEN, Hong Kong (HK)

(72) Inventor: Juan Hong CHEN, Hong Kong (HK)

(21) Appl. No.: 13/545,946

(22) Filed: Jul. 10, 2012

(30) Foreign Application Priority Data
Mar. 13, 2012 (CN) 201210064790.0

(51) Int. Cl. B65D 37/00; B67D 7/06

(52) U.S. Cl. 222/181.3; 222/207

(57) ABSTRACT

The present application is directed to a fluid extrusion bottle, including a flexible bottle body which includes an interior container, a bottom section of the bottle body includes a fluid exit tunnel, a bottom end of the fluid exit tunnel and the interior container are connected, a upper end of the fluid exit tunnel includes a fluid exit mouth. The bottle body includes a temperature elevation storage space that neighbors the fluid exit tunnel, including a medium interchangeable tunnel that connects to the fluid exit tunnel, the medium interchangeable tunnel includes a gas changeable tunnel that is proximal to the fluid exit mouth and a fluid changeable tunnel that is distal from the fluid exit mouth. The fluid extrusion bottle can raise the fluid extrusion efficiency of the bottle and reduce remains. The structure of the bottle is simple, the production cost is low and is convenient to recycle.

### CROSS-REFERENCE TO RELATED APPLICATIONS

This application claims the benefit of Chinese Patent Application No. 201210064790.0, filed on Mar. 13, 2012; the contents of which is hereby incorporated by reference.

### TECHNICAL FIELD

The present application is directed to a fluid bottle, more specifically, a fluid extrusion bottle that contains a temperature elevation storage space.

### BACKGROUND

The present existing containers for storing bath foam, shampoo, hand foam, etc, can generally be classified into two kinds, one is a bottle containing a pump while the other is a bottle with fluid extrusion capability.

### SUMMARY

The technical problem that the present application seeks to solve is, while directing at the deficiency in low extrusion efficiency for the presently existing fluid extrusion bottle carrying a temperature compensating space that is part of the fluid exit tunnel, providing a kind of fluid extrusion bottle that includes a temperature elevation storage space that is independent from the fluid exit tunnel.

A fluid extrusion bottle, includes a flexible bottle body. The bottle body includes an interior container that stores fluid, a bottom section of the bottle body includes a fluid exit tunnel that extends from the bottom section upwardly in a curvature, a bottom end of the fluid exit tunnel and the interior container are connected, a upper end of the fluid exit tunnel includes a fluid exit mouth, the bottle body also includes a temperature elevation storage space that neighbors the fluid exit tunnel, the temperature elevation storage space includes a medium interchangeable tunnel that connects to the fluid exit tunnel, the medium interchangeable tunnel includes a gas changeable tunnel that is proximal to the fluid exit mouth and a fluid changeable tunnel that is distal from the fluid exit mouth.

The fluid exit tunnel may be initially upwardly curved, and then forwardly curved.

The bottle body may include a left side, a right side, a top section, and a backboard configured for being stuck on the wall, wherein the backboard is connected to the left side, the right side and the top section through a first flexible deformation section, a second flexible deformation section, a third flexible deformation section, respectively; the first and second flexible deformation sections are extended towards a vertical direction.

Cross sections of the first, second and third flexible deformation sections may be “U” shaped.

The first and second flexible deformation sections may be progressively widened from top to bottom.

An upper section of the backboard may be configured with hanging buckles and/or two-sided adhesive.

The fluid exit tunnel may be located at the center of the bottom section and the first and second flexible deformation sections may be extended from an upper section to a lower section of the bottle body.

An end surface of the fluid exit mouth and an uppermost front side of the bottle body may belong to the same plane.

The bottom section of the bottle body may include a bottle supporting base configured for standing the bottle body on a horizontal plane.

The fluid exit tunnel may be extended from the bottom section initially in an upwardly slanted direction, then extended at a surface level direction.

The medium interchangeable tunnel may be an open mouth on a wall surface of the temperature elevation storage space that neighbors the fluid exit tunnel, wherein the gas changeable tunnel covers a region within the open mouth that lies proximal to the fluid exit mouth and the fluid changeable tunnel covers a region within the open mouth that lies distal from the fluid exit mouth.

The gas changeable tunnel may be a gas hole on a wall surface of the temperature elevation storage space that neighbors the fluid exit tunnel and the fluid changeable tunnel may be a fluid hole on the wall surface of the temperature elevation storage space that neighbors the fluid exit tunnel.

The fluid hole may be located at the bottom section of the temperature elevation storage space. The bottom section of the temperature elevation storage space may be higher than or leveling with the fluid surface inside the fluid exit tunnel when the bottle has not yet been pressured.

The area of the fluid hole may be smaller than the area of the fluid exit mouth.

The temperature elevation storage space and the fluid exit tunnel are correspondingly independent, while both can limitedly interconnect through medium exchangeable tunnel, the fluid extrusion efficiency can be raised when the extrusion bottle is compressed, and hence reduce remains. Furthermore, the construction of the bottle is simple. As only one material is required for producing the bottle, the cost of production is low and enhance re-cycling and becomes more environmental-friendly.

### BRIEF DESCRIPTION OF THE DRAWINGS

Below is a further explanation of the present application with the drawings and embodiment combined, in the drawings:

FIG. 1 is a side view of a first embodiment of a fluid extrusion bottle of the present application;

FIG. 2 is a front view of the first embodiment of the fluid extrusion bottle of the present application;

FIG. 3 is a I-I cross-sectional view of FIG. 2;

FIG. 4 is a II-II cross-sectional view of FIG. 2;

FIG. 5 is an illustrative view of a normal stationary position of the bottle preventing fluid spillage due to the curvature of the fluid exit tunnel of the first embodiment of the fluid extrusion bottle of the present application;

FIG. 6 is a top view of the first embodiment of the fluid extrusion bottle of the present application;

FIG. 7 is an illustrative view of the bottle in actual use of the first embodiment of the fluid extrusion bottle of the present application;

FIG. 8 is an illustrative view of the bottle in deformed and extruded state of the first embodiment of the fluid extrusion bottle of the present application;

FIG. 9 is an illustrative view of the bottle after accidentally fell down of the first embodiment of the fluid extrusion bottle of the present application;

FIG. 10 is a front view of a second embodiment of the fluid extrusion bottle of the present application;

FIG. 11 is a I-I cross-sectional view of FIG. 10;

FIG. 12 is a II-II cross-sectional view of FIG. 11;

FIG. 13 is a side view of the second embodiment of the fluid extrusion bottle of the present application;

FIG. 14 is an illustrative view of the bottle after backwardly fell down of the second embodiment of the fluid extrusion bottle of the present application;

FIG. 15 is an illustrative view of the bottle after forwardly fell down of the second embodiment of the fluid extrusion bottle of the present application.

### DETAILED DESCRIPTION

In order to obtain a clearer understanding of the technical features, purpose and result of the present application, below is a detailed explanation together with drawings of the preferred embodiment of the present application.

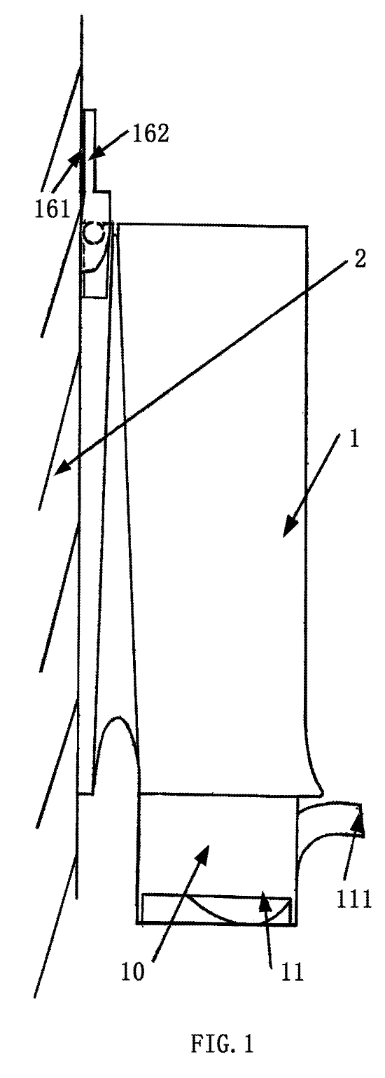

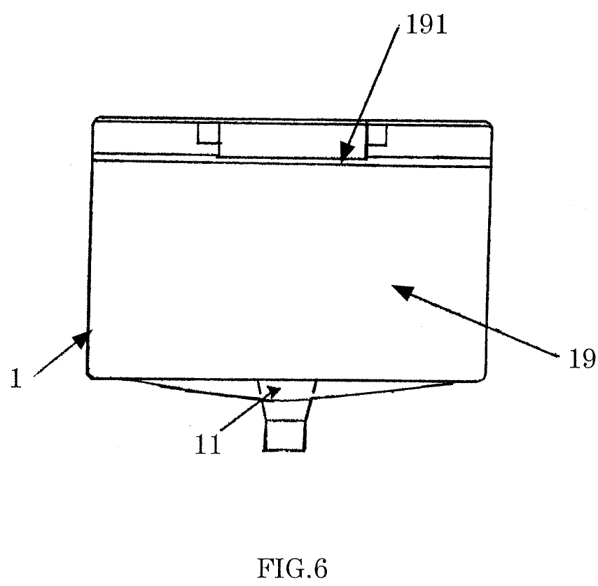

FIGS. 1, 2 and 6 illustrate a first embodiment of a fluid extrusion bottle of the present application, the embodiment shows a wall-hanging type of fluid extrusion bottle, which is hung on the wall 2 when in use.

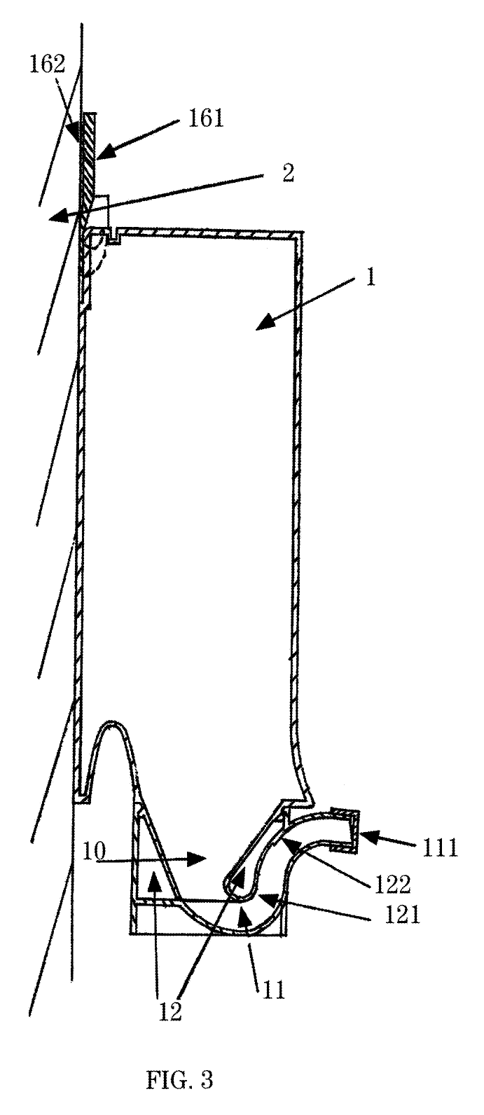

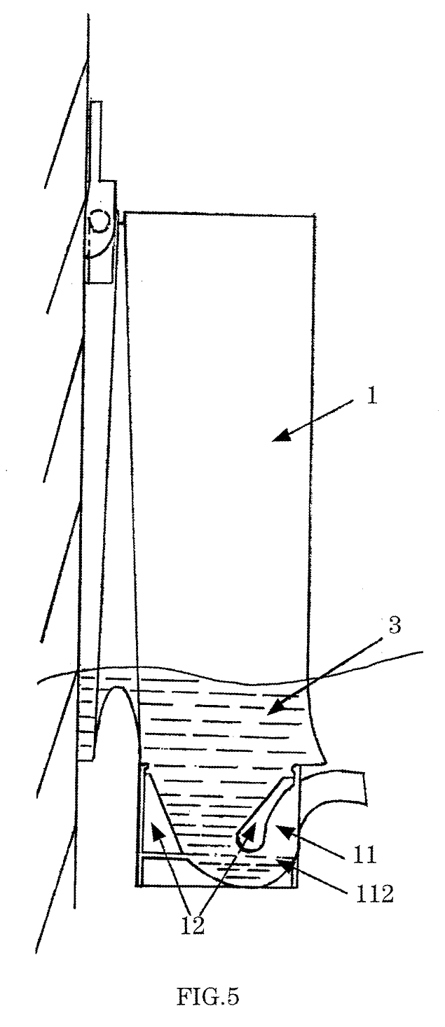

The embodiment of the fluid extrusion bottle includes a flexible bottle body 1. When suppressed, the bottle body 1 will undergo flexible deformation. When suppression is released, bottle body 1 will return to original form. Bottle body 1 contains an interior container to store fluids. Please see FIGS. 3 and 5. In the embodiment, the bottom section 10 of bottle body 1 contains a fluid exit tunnel 11 that is extended upwardly in a curvature from bottom section 10. The bottom end of the interior container of the bottle body 1 and the fluid exit tunnel 11 are inter-connected, the top end of the fluid exit tunnel 11 contains a fluid exit mouth 111. When the fluid extrusion bottle has been hung on the wall, the upper section of the interior container of the bottle body 1 will have a negative pressure, and relies on the curvature design of the fluid exit tunnel 11 to prevent air from entering the bottle body 1, which can allow the exterior and interior pressure to remain in balance and keep the fluid to maintain inside the interior container of the bottle body 1.

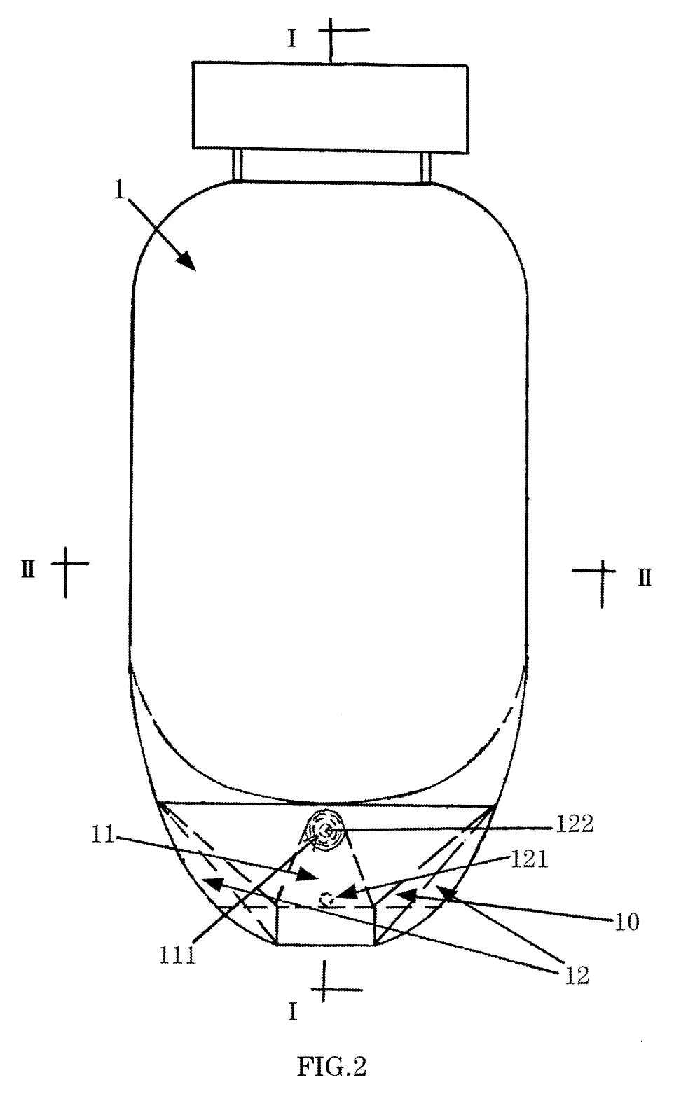

Referring to FIGS. 2, 3 and 5, in order to prevent any changes in the volume of the fluid 3 and air inside bottle body 1 during changes in temperature and cause leakage in fluids, the embodiment shows that bottle body 1 also contains a temperature elevation storage space 12 that neighbors the fluid exit tunnel 11. The temperature elevation storage space 12 includes a medium interchangeable tunnel that is connected to the fluid exit tunnel 11. Medium interchangeable tunnel includes gas changeable tunnel that is located proximal to the fluid exit mouth 111 and fluid changeable tunnel that is located distal from the fluid exit mouth 111. The medium interchangeable tunnel can be an open mouth on the wall surface of the temperature elevation storage space 12 that neighbors the fluid exit tunnel 111. At that time, gas changeable tunnel is the region within the open mouth that is proximal to fluid exit mouth 111. Fluid changeable tunnel is the region within the open mouth that is distal from the fluid exit mouth 111. In another word, the gas changeable tunnel and the fluid changeable tunnel on the wall surface are inter-connected. When the open mouth is, for example, structured as a slit, a continuous slit would be formed when the gas changeable tunnel and the fluid changeable tunnel combine together.

Medium interchangeable tunnel can also includes correspondingly independent gas changeable tunnel and fluid changeable tunnel. Under such design, gas changeable tunnel is a gas hole 122 on the wall surface of the temperature elevation storage space 12 that neighbors the fluid exit tunnel 11. Fluid changeable tunnel is a fluid hole 121 on the wall surface of the temperature elevation storage space 12 that neighbors the fluid exit tunnel 11. In another word, gas changeable tunnel and fluid changeable tunnel are correspondingly separated on the wall surface.

Referring to FIGS. 2, 3 and 5, the bottom section of the temperature elevation storage space 12 is higher than or leveling up with the fluid surface 112 inside the fluid exit tunnel 11 when the bottle body 1 has not been pressured. The fluid hole 121 that is connected to the fluid exit tunnel 11 is located at the bottom section of the temperature elevation storage space 12, the gas hole 122 that is connected to the upper section of the fluid exit tunnel 11 is located at the upper section of the temperature elevation storage space 12. In preference, the area of the fluid hole 121 and the gas hole 122 can be set to be smaller than the area of the fluid exit mouth 111.

The medium interchangeable tunnel can be round, square and slit etc in shape providing the medium with a structure for entry and exit. For example, when the medium interchangeable tunnel is an open mouth on the wall surface that is connected to the gas changeable tunnel and the fluid changeable tunnel, a slit that is extended towards the fluid exit direction can be designed. When the medium interchangeable tunnel is designed in separating the gas changeable tunnel and the fluid changeable tunnel, fluid hole 121 and gas hole 122 can be individually, for example, a round shaped opening. When the temperature in the environment elevates in bottle body 1 that is in a reserved status, the air and fluid 3 in the interior container of bottle body 1 will expand according to temperature elevation, the fluid surface 112 inside the fluid exit tunnel 11 will progressively elevates. When elevation reaches the level as that of the fluid hole 121 in the temperature elevation storage space 12, fluid will enter the temperature elevation storage space 12 and air inside the temperature elevation storage space 12 will be released from the gas hole 122. When temperature is lowered, the air and fluid 3 in the interior of bottle body 1 will contract as temperature is lowered and will create a negative pressure inside the fluid exit tunnel 11. The fluid inside the temperature elevation storage space 12 will be sucked back into the interior container of the bottle body 1. Since elevation in temperature is generally slow in normal condition, no large amount of fluid will fill inside the fluid exit tunnel 11 within a short period of time. Fluid can slowly enter and exit the temperature elevation storage space 12. Similarly, when the medium interchangeable tunnel is structured as a slit that is extended towards fluid exit direction, since the elevation of the fluid surface 112 inside the fluid exit tunnel 11 is slowly progressed in the process of temperature elevation and expansion, fluid enters the temperature elevation storage space 12 through the lower section of the slit, and air inside the temperature elevation storage space 12 can, at this moment, be released to the fluid exit tunnel 11 through the upper section of the slit.

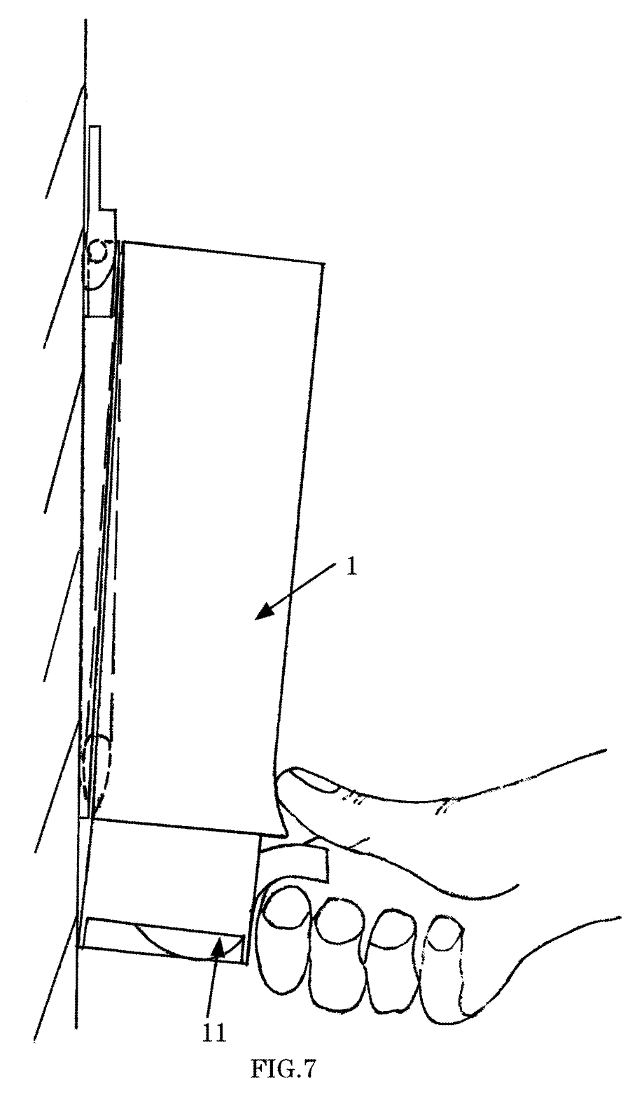

As FIG. 7 illustrates, when the bottle body 1 is suppressed, the volume of the interior container of the bottle body 1 is decreased and the pressure is increased, hence a large amount of fluid is rushed towards the fluid exit tunnel 11. Since the temperature elevation storage space 12 is a closed space besides having the fluid hole 121 and the gas hole 122, when fluid passes by fluid hole 121 and gas hole 122, it may be at a certain level blocked by the air trapped inside the temperature elevation storage space 12 and not be able to enter successfully into the temperature elevation storage space 12. Hence, large amount of fluids will be discharged from the bottle through the fluid exit mouth 111 of the fluid exit tunnel 11, while at most only a small amount of fluids enter the temperature elevation storage space 12.

Further, in order to satisfy the work required to be done in the temperature elevation storage space 12 by both the fluid hole 121 and gas hole 122, the area of the fluid hole 121 and gas hole 122 can be as minimal as possible, preferably, the area of the fluid hole 121 and gas hole 122 should be smaller than the area of the fluid exit mouth 111, so as to raise the efficiency of fluid extrusion.

Setting the fluid hole 121 at the bottom section of the temperature elevation storage space 12, and the bottom section of the temperature elevation storage space 12 to be at a level higher than or leveling up with the fluid surface inside the fluid exit tunnel 11 when the bottle body 1 has not been pressured, can cause all the fluids to flow back outside the fluid exit tunnel 11 when backwashing, thus prevent wasting.

Referring to FIGS. 1 and 3, as the embodiment is a wall-hanging type of the fluid extrusion bottle, bottle body 1 includes a backboard 13 that aligns the wall. In order to make it more convenient to situate the fluid extrusion bottle, the upper section of the backboard 13 contains hanging buckles 161 and two-sided adhesive 162. The two-sided adhesive 162 can be adhered between the wall 2 and hanging buckles 161, and the bottle body 1 can be installed without the need of supporting and without the need of installing screws through boring holes on the wall, hence making it convenient to use. Obviously, as common understanding, the use of either hanging buckles 161 or two-sided adhesive 162 can also situate bottle body 1.

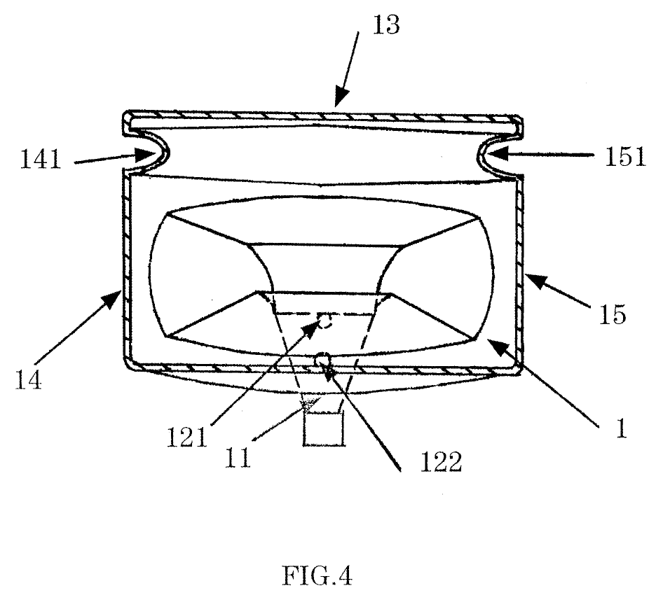

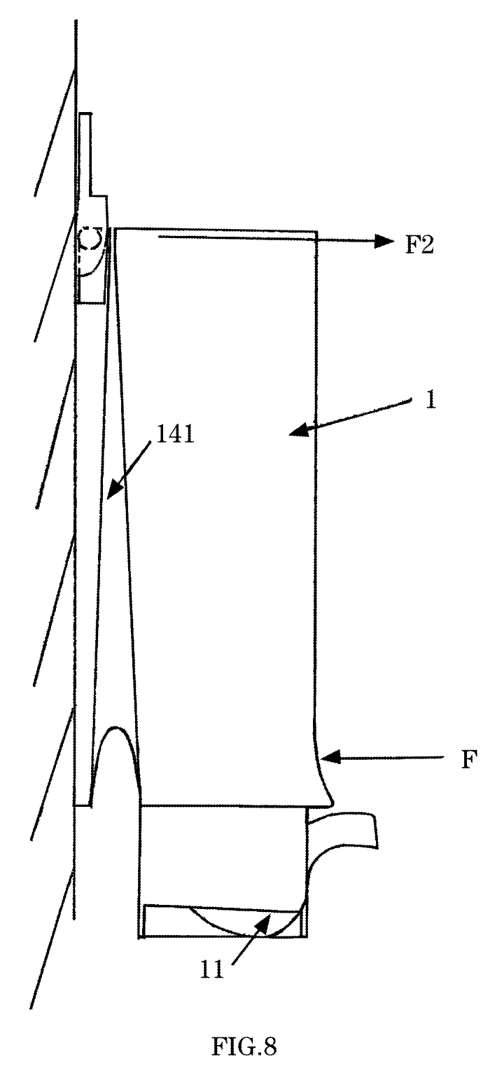

Referring to FIGS. 1, 4, 6, 7 and 8, in order to make the extrusion and deformation of the bottle body 1 easier and extrude in one trial of extrusion sufficient amount of fluid, in the embodiment, the backboard 13 is connected between the left side 14 and the right side 15 through a first flexible deformation section 141 and a second flexible deformation section 151 that are extended towards vertical direction, respectively, the backboard 13 is connected to the top section 19 through a third flexible deformation section 191. The cross sections of the first, second and third flexible deformation sections 141, 151 and 191 are “U” shaped. Further, the first and second flexible deformation sections 141 and 151 are progressively widened from top to bottom. Since the cross sections of the first, second and third flexible deformation sections 141, 151 and 191 are “U” shaped, extrusion is easier. The change in volume of the bottle body 1 is relatively large, bottle body 1 can more easily return to its original form after suppression. In the present embodiment, the fluid exit tunnel 11 is located at the center of the bottom section 10. The first and second flexible deformation sections 141 and 151 are extended downward from the upper section of bottle body 1. The design of the “U” shaped cross sections of the first and second flexible deformation sections 141 and 151 enables extrusion to become easier and the bottle can return to its original form more easily. In view of the previous design (Chinese Design Patent No. CN2839130Y), the force (F2) produced against the hanging buckles under the force (F) of the bottle and the reaction force of the wall is relatively small, or even F2 may not be produced so as to prevent the two-sided adhesive 162 from being torn off from the wall due to excessive force F2.

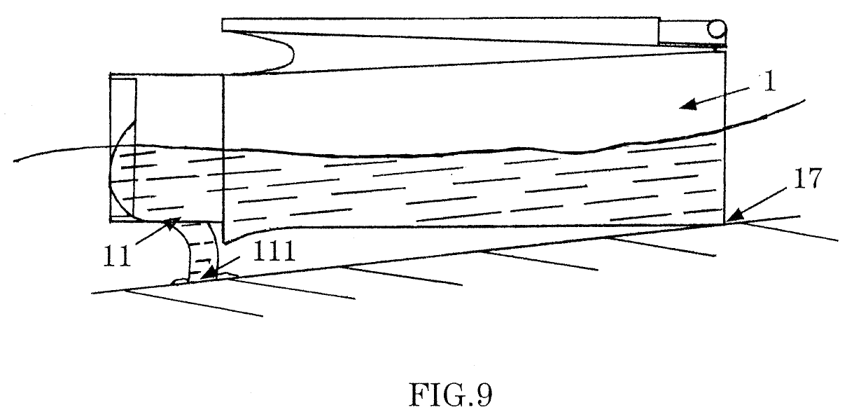

Referring to FIGS. 1 and 9, furthermore, in order to prevent large amount of fluid from spilling out due to accidental collapsing of the bottle, in the present embodiment, fluid exit tunnel 11 is preferably initially upwardly curved and then forwardly curved in shape, while the end surface of the fluid exit mouth 111 of the fluid exit tunnel and uppermost front side 17 of bottle body 1 belong to the same plane. That way, even if bottle body 1 accidentally collapsed as shown in FIG. 9, since the fluid exit mouth 111 is lying flat on the ground, the gap between the fluid exit mouth and the ground is sealed after small amount of fluid is spilled out, rendering air unable to enter the bottle body 1 and fluid inside the interior container of the bottle body 1 will not leak outside. When the fluid exit mouth 111 is in an upward position, the fluid inside the interior container of bottle body 1 will not leak from the fluid exit tunnel 11.

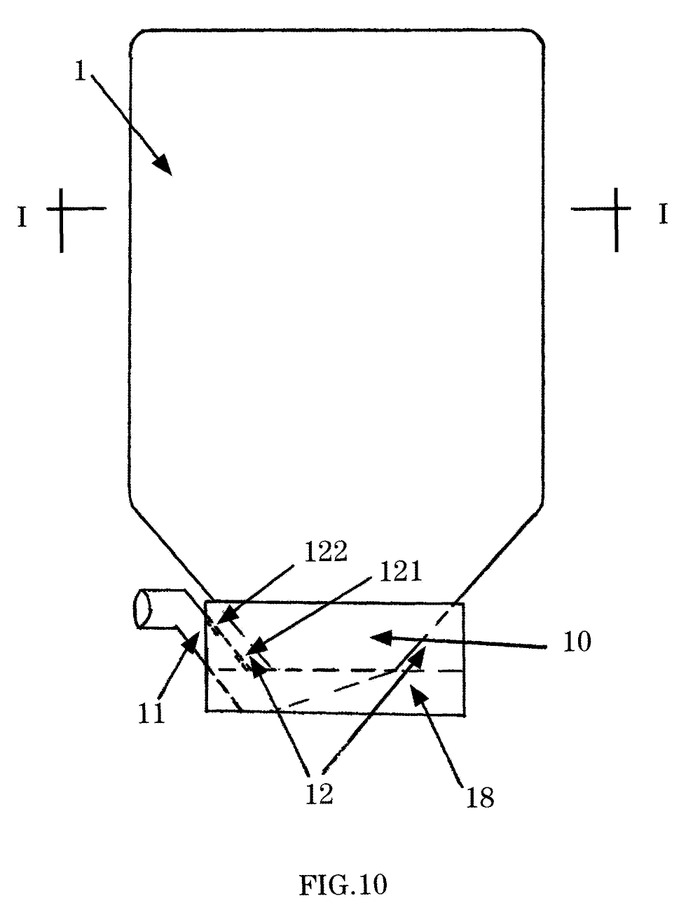

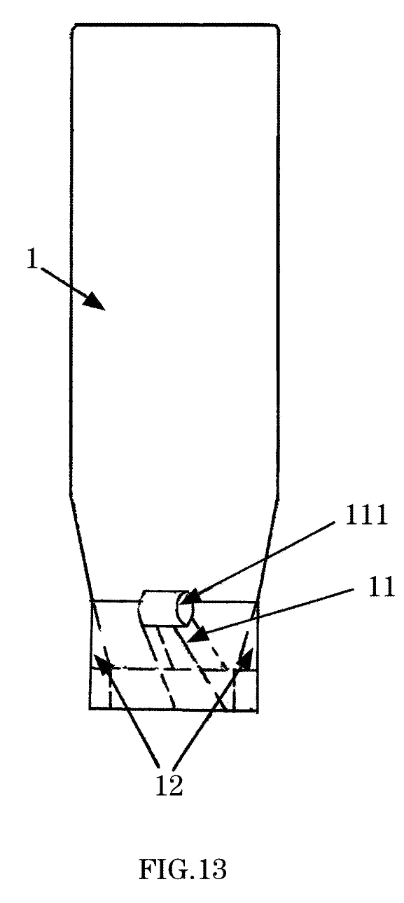

As FIGS. 10 and 13 illustrate, as a second embodiment of the fluid extrusion bottle of the present application, the embodiment shows a fluid extrusion bottle as a vertical standing fluid extrusion bottle. The vertical standing fluid extrusion bottle includes a flexible bottle body 1, the bottle body 1 has an interior container for storing fluid, the bottle body 1 can flexibly deform when being externally pressured. In order to allow the bottle body 1 to stand vertically on the platform, the bottom section of bottle body 1 contains a supporting base 18 for allowing the bottle body 1 to stand above the horizontal surface level, the bottom of the supporting base 18 can stand on the platform.

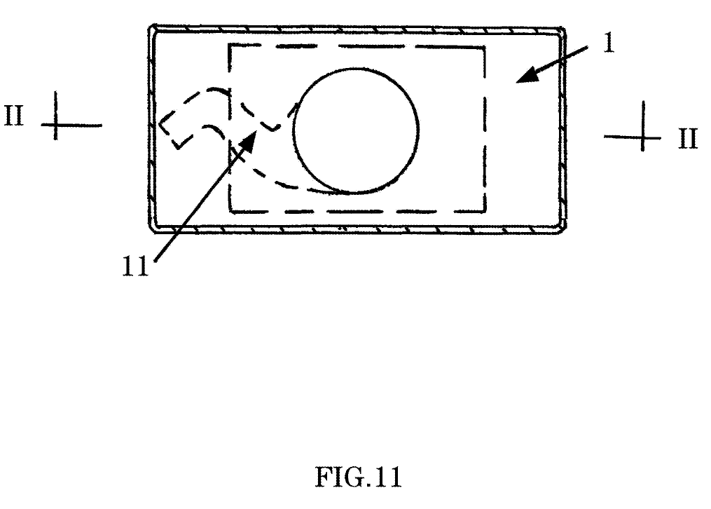

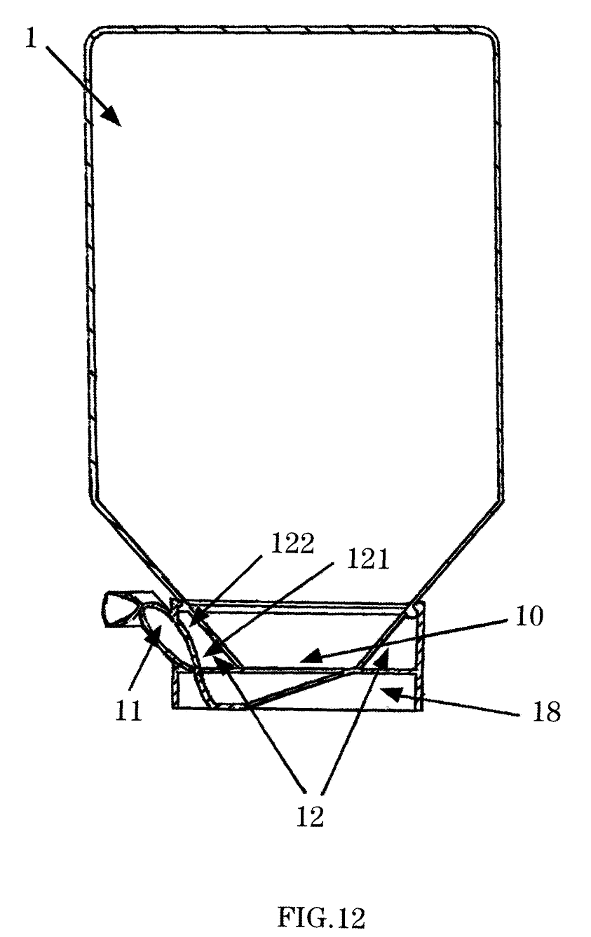

Referring to FIGS. 11, 12 and 13, in the present embodiment, the bottom 10 of bottle body 1 includes a fluid exit tunnel 11 that is extended from the bottom 10 and upwardly curved. The bottom end of the fluid exit tunnel 11 and the interior container of the bottle body 1 are connected, the upper end of the fluid exit tunnel 11 contains a fluid exit mouth 111, bottle body 1 also includes a temperature elevation storage space 12 that neighbors the fluid exit tunnel 11. The bottom of the temperature elevation storage space 12 is higher than or in leveling with the fluid surface inside the fluid exit tunnel 11 when the bottle has not been pressured. The bottom of the temperature elevation storage space 12 contains fluid hole 121 that is connected to the fluid exit tunnel 11. The upper section of the temperature elevation storage space 12 contains gas hole 122 that is connected to the upper section of the fluid exit tunnel 11. In the present embodiment, the working principle of the temperature elevation storage space 12 is the same as that of the temperature elevation storage space of the wall hanging type fluid extrusion bottle in the first embodiment, and hence will not be reiterated.

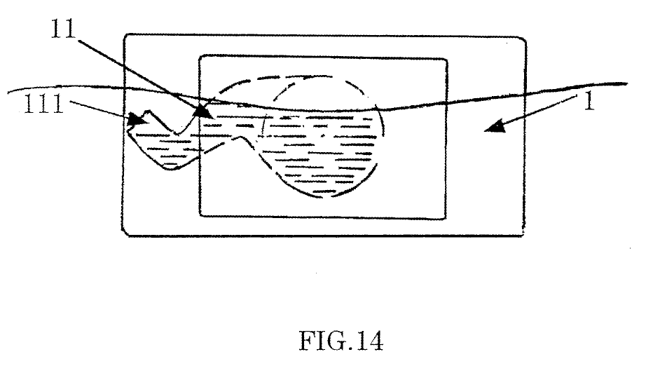

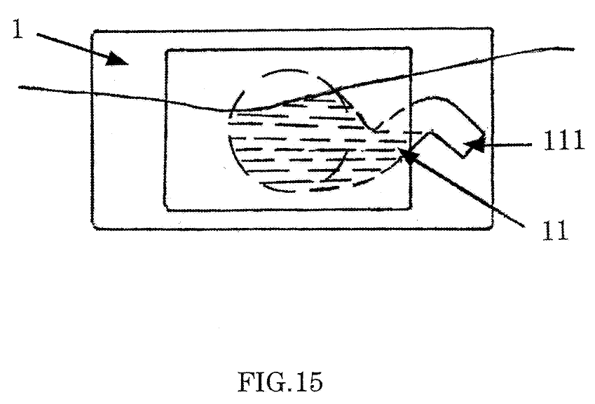

Referring to FIGS. 13, 14 and 15, in order to prevent the fluid inside the bottle body 1 from leaking when the bottle body 1 collapses, in the present embodiment, furthermore, the fluid exit tunnel 11 of bottle body 1 is preferably extended from the bottom 10 initially upwardly at an angled direction and then extended at a horizontal surface level direction. That way, no matter whether the bottle body 1 is falling backward, as shown in FIG. 14, or is falling forward, as shown in FIG. 15, the curvature of the fluid exit tunnel 11 can always prevent the fluid from leakage outside of the bottle body 1.

In the fluid extrusion bottle of the present application, the temperature elevation storage space and the fluid exit tunnel are correspondingly independent, both can be limitedly connected through a medium interchangeable tunnel, which can raise the fluid extrusion efficiency of the fluid extrusion bottle and reduce waste. The structure of the bottle of the fluid extrusion bottle of the present application is simple, which can be produced from only one material such as by plastic molding, and is low in production costs and convenient for recycling, thus more environmental friendly. Further, for the wall hanging type fluid extrusion bottle, the operation is very convenient as a single hand can complete the action of fluid extrusion, hence providing convenience to the user.

The aforementioned together with the drawings have described the embodiments of the present application. However, the present application is not confined to the above general embodiments. The above-mentioned general embodiment is merely illustrative instead of limitative in nature. Common technicians in the field can also perform many other forms under the disclosure of the present application without departing from the objectives of the present application and the protective scope as recited in the claims, which are all belonging within the protective scope of the present application.

1. A fluid extrusion bottle, comprising: a flexible bottle body, wherein the bottle body comprises an interior container that stores fluid, a bottom section of the bottle body comprises a fluid exit tunnel that extends from the bottom section upwardly in a curvature, a bottom end of the fluid exit tunnel and the interior container are connected, a upper end of the fluid exit tunnel comprises a fluid exit mouth, the bottle body also comprises a temperature elevation storage space that neighbors the fluid exit tunnel, the temperature elevation storage space comprises a medium interchangeable tunnel that connects to the fluid exit tunnel, the medium interchangeable tunnel comprises a gas changeable tunnel that is proximal to the fluid exit mouth and a fluid changeable tunnel that is distal from the fluid exit mouth.

2. The fluid extrusion bottle of claim 1, wherein the fluid exit tunnel is initially upwardly curved, and then forwardly curved.

3. The fluid extrusion bottle of claim 1, wherein the bottle body comprises a left side, a right side, a top section, and a backboard configured for being stuck on the wall, wherein the backboard is connected to the left side, the right side and the top section through a first flexible deformation section, a second flexible deformation section, a third flexible deformation section, respectively; the first and second flexible deformation sections are extended towards a vertical direction.

4. The fluid extrusion bottle of claim 3, wherein cross sections of the first, second and third flexible deformation sections are “U” shaped.

5. The fluid extrusion bottle of claim 4, wherein the first and second flexible deformation sections are progressively widened from top to bottom.

6. The fluid extrusion bottle of claim 3, wherein an upper section of the backboard is configured with hanging buckles and/or two-sided adhesive.

7. The fluid extrusion bottle of claim 4, wherein the fluid exit tunnel is located at the center of the bottom section, and the first and second flexible deformation sections are extended from an upper section to a lower section of the bottle body.

8. The fluid extrusion bottle of claim 1, wherein an end surface of the fluid exit mouth and an uppermost front side of the bottle body belong to the same plane.

9. The fluid extrusion bottle of claim 1, wherein the bottom section of the bottle body comprises a bottle supporting base configured for standing the bottle body on a horizontal plane.

10. The fluid extrusion bottle of claim 1, wherein the fluid exit tunnel is extended from the bottom section initially in an upwardly slanted direction, then extended at a surface level direction.

11. The fluid extrusion bottle of claim 1, wherein the medium interchangeable tunnel is an open mouth on a wall surface of the temperature elevation storage space that neighbors the fluid exit tunnel, wherein the gas changeable tunnel covers a region within the open mouth that lies proximal to the fluid exit mouth and the fluid changeable tunnel covers a region within the open mouth that lies distal from the fluid exit mouth.

12. The fluid extrusion bottle of claim 1, wherein the gas changeable tunnel comprises a gas hole on a wall surface of the temperature elevation storage space that neighbors the fluid exit tunnel, and the fluid changeable tunnel comprises a fluid hole on the wall surface of the temperature elevation storage space that neighbors the fluid exit tunnel.

13. The fluid extrusion bottle of claim 12, wherein the fluid hole is located at a bottom section of the temperature elevation storage space, and the bottom section of the temperature elevation storage space is higher than or in leveling with a fluid surface inside the fluid exit tunnel when the bottle body has not been pressured.
